(19) United States
(12) Patent Application Publication
(10) Pub. No.: US 2012/0193178 A1
(43) Pub. Date: Aug. 2, 2012

(54) ELECTRIC PARKING BRAKE DEVICE

(75) Inventors: Jin Yamada, Kariya-shi (JP); Akihito Kusano, Toyota-shi (JP); Eiji Inaya, Toyota-shi (JP); Hironori Araki, Toyota-shi (JP)

(73) Assignees: HOSEI BRAKE INDUSTRY CO., LTD., Toyota-shi (JP); ADVICS CO., LTD., Kariya-shi (JP)

(21) Appl. No.: 13/362,700

(22) Filed: Jan. 31, 2012

(30) Foreign Application Priority Data
Feb. 2, 2011 (JP) 2011-020500

(51) Int. Cl. F16D 65/22

(52) U.S. Cl. 188/162

(57) ABSTRACT

In an electric parking brake device, the force line of a motion transmitting force at a contact portion between a motion transmitting member and an intervention member is located inside of an outer surface of an engaging portion between a screw shaft member and a nut member. Thus, when a linear motion of the screw shaft member causes the parking lever to pivotally move, no floating takes place at the engaging portion, so that a one-side hitting can be prevented at the engaging portion. Therefore, the parking lever can be pivotally moved smoothly. Further, one surface of the motion transmitting member contacting the intervention member takes a curved surface to suppress a slippage in the movement that the parking lever is pivotally moved. Therefore, the motion transmitting force by the motion transmitting member can be prevented from becoming an offset load, realizing a smooth pivot movement of the parking lever.

### INCORPORATION BY REFERENCE

This application is based on and claims priority under 35 U.S.C. 119 with respect to Japanese Application No. 2011-020500 filed on Feb. 2, 2011, the entire content of which is incorporated herein by reference.

### BACKGROUND OF THE INVENTION

1. Field of the Invention

The present invention relates to an electric parking brake device, and particularly, to an electric parking brake device in which a parking lever for bringing brake linings on brake shoes into friction engagements with a drum is pivotally moved by an electric motor.

2. Discussion of the Related Art

For example, Japanese published patent application JP 11-105680 A describes an electric paring brake device as noted below. In the electric paring brake device, an electric motor and a parking lever whose one end is pivotably supported on one of the brake shoes are connected through a gear mechanism, a ball-screw mechanism and a slide shaft. Further, the slide shaft is secured to a nut of the ball-screw mechanism at one end and is secured to a free end of the parking lever at the other end. In the electric paring brake device, the rotational motion of the motor is converted by the ball-screw mechanism into a linear motion, and the linear motion causes the slide shaft to slide, whereby the parking lever is drawn. Thus, the parking lever is pivotally moved about a pivot support portion at its one end and widens the pair of shoes against the drum to bring the pair of brake linings into friction engagements with the drum.

In the aforementioned electric paring brake device, the linear motion of the slide shaft causes the parking lever to pivotally move. Thus, an anxiety arises in that a floating and hence, a one-side hitting occur at an engaging portion between the nut and a ball screw of the ball-screw mechanism connected to the slide shaft, thereby obstructing a smooth pivot movement of the parking lever.

### SUMMARY OF THE INVENTION

Accordingly, it is a primary object of the present invention to provide an improved electric parking brake device capable of smoothly performing the pivot movement of a parking lever.

Briefly, according to the present invention, there is provided an electric parking brake device, which comprises a pair of brake shoes respectively having brake linings frictionally engageable with a drum and pivotally supported on a back plate; a parking lever pivotally supported by one of the brake shoes at one end thereof and having a connecting member interposed between itself and the other of the brake shoes for widening the pair of brake shoes against the drum to bring the pair of brake linings into friction engagements with the drum when pivotally moved; an electric motor secured to the back plate; a rotation-linear motion converting mechanism having a rotation member and an axially movable member mutually engaged at an engaging portion for converting a rotational motion to a linear motion when the rotation member is rotationally driven by the electric motor with the axially movable member restrained from rotating; and a motion transmitting member connected to the axially movable member for transmitting the linear motion converted by the rotation-linear motion converting mechanism to the other end of the parking lever through a contact with the other end of the parking lever. A contact portion between the motion transmitting member and the other end of the parking lever is formed so that the force line of a motion transmitting force at the contact portion between the motion transmitting member and the other end of the parking lever is located inside an outer surface of the engaging portion between the rotation member and the axially movable member.

With this construction, the aforementioned contact portion is formed so that the force line of the motion transmitting force at the contact portion between the motion transmitting member and the other end of the parking lever is located inside the outer surface of the engaging portion between the rotation member and the axially movable member. If the force line of the motion transmitting force were located outside the outer surface of the engaging portion between the rotation member and the axially movable member, in addition to the force exerted at the engaging portion between the axially movable member and the rotation member, a moment in a direction perpendicular to the axis of the axially movable member would be exerted on the axially movable member to urge the axially movable member to revolve, and thus, it would be the case occasionally that a floating takes place at the engaging portion between the rotation member and the axially movable member to bring about a one-side hitting therebetween. In the present invention, on the contrary, the force line of the motion transmitting force is located inside the outer surface of the engaging portion between the rotation member and the axially movable member. In this case, only the force acting at the engaging portion between the axially movable member and the rotation member is exerted on the axially movable member, and there is not produced any moment that causes the aforementioned axially movable member to revolve. Thus, no floating takes place at the engaging portion between the rotation member and the axially movable member, so that the one-side hitting at the engaging portion can be prevented. Therefore, the pivot movement of the parking lever can be carried out smoothly.

### BRIEF DESCRIPTION OF THE ACCOMPANYING DRAWINGS

The foregoing and other objects and many of the attendant advantages of the present invention may readily be appreciated as the same becomes better understood by reference to the preferred embodiment of the present invention when considered in connection with the accompanying drawings, wherein like reference numerals designate the same or corresponding parts throughout several views, and in which:

FIG. 1 is a front view showing an embodiment of an electric parking brake device according to the present invention as viewed in a center axis direction of a drum;

FIGS. 2(A) and 2(B) are views showing a parking lever and a motor-driven actuator of the electric parking brake device in FIG. 1 as viewed respectively in a direction perpendicular to the center axis direction of the drum and in the center axis direction of the drum;

FIGS. 3(A) and 3(B) are views showing the details of a main part of the parking lever and the motor-driven actuator as viewed respectively in a direction perpendicular to the center axis of the drum and in the direction of the center axis of the drum, and FIG. 3(C) is a sectional view taken along the line A-A in FIG. 3(B);

FIG. 4 is a view for explaining the operation of a motion transmitting member in the motor-driven actuator; and

FIG. 5 is a view for explaining the operation of the parking lever.

### DETAILED DESCRIPTION OF THE PREFERRED EMBODIMENT

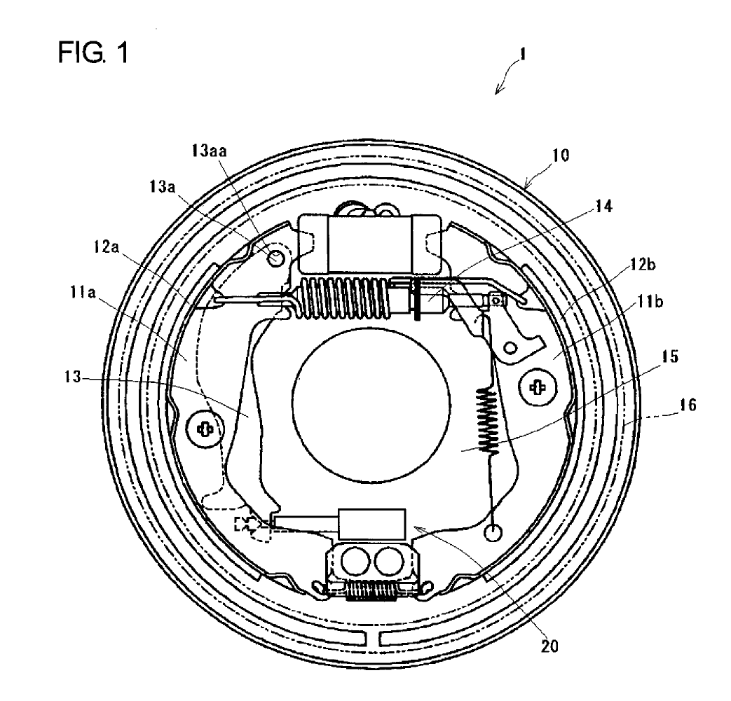

Hereinafter, an embodiment of the present invention will be described with reference to the accompanying drawings. As shown in FIG. 1, an electric parking brake device 1 comprises a drum brake 10 with a parking brake mechanism and a motor-driven actuator 20 for pivotally moving a parking lever 13 referred to later.

The drum brake 10 is mainly composed of a pair of brake shoes 11a and 11b, a pair of brake linings 12a and 12b, a parking lever 13, a connecting member 14, and a back plate 15.

The pair of brake shoes 11a, 11b each take an arc shape and have the pair of brake linings 12a, 12b fixed on outer circumference sides thereof. The pair of brake shoes 11a, 11b are pivotably supported on the back plate 15 so that they are on both sides of the center of the drum 16 and are able to bring the pair of brake linings 12a, 12b into contact with, and separation from, the inner circumference of the drum 16.

The parking lever 13 is pivotably supported by one (on the left side as viewed in FIG. 1) of the brake shoes 11a at its one end portion and is arranged along the brake shoe 11a. The parking lever 13 has the connecting member 14 interposed between itself and the other brake shoe 11b. A pivot support portion 13a for the parking lever 13 is formed with a through hole 13aa which permits the parking lever 13 to tilt.

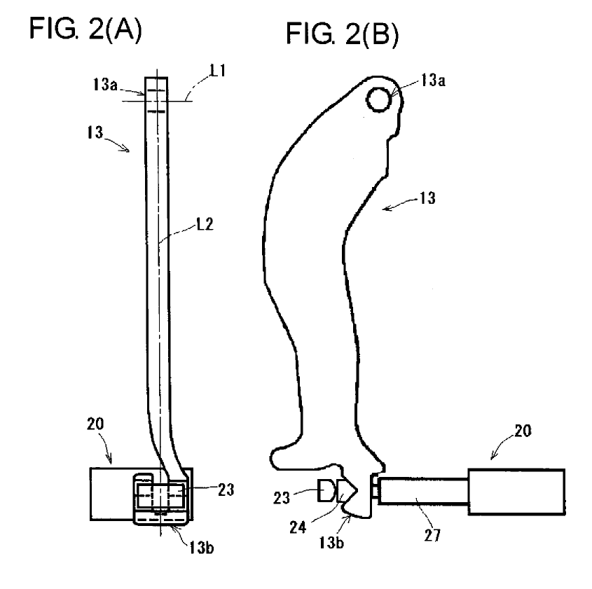

As shown in FIGS. 2(A) and 2(B), the parking lever 13 is bent on the other end side to take an about J-letter shape which is almost symmetrical with respect to a lever axis L2 of the parking lever 13 perpendicularly intersecting the pivot axis L1 of the pivot support portion 13a on one end side.

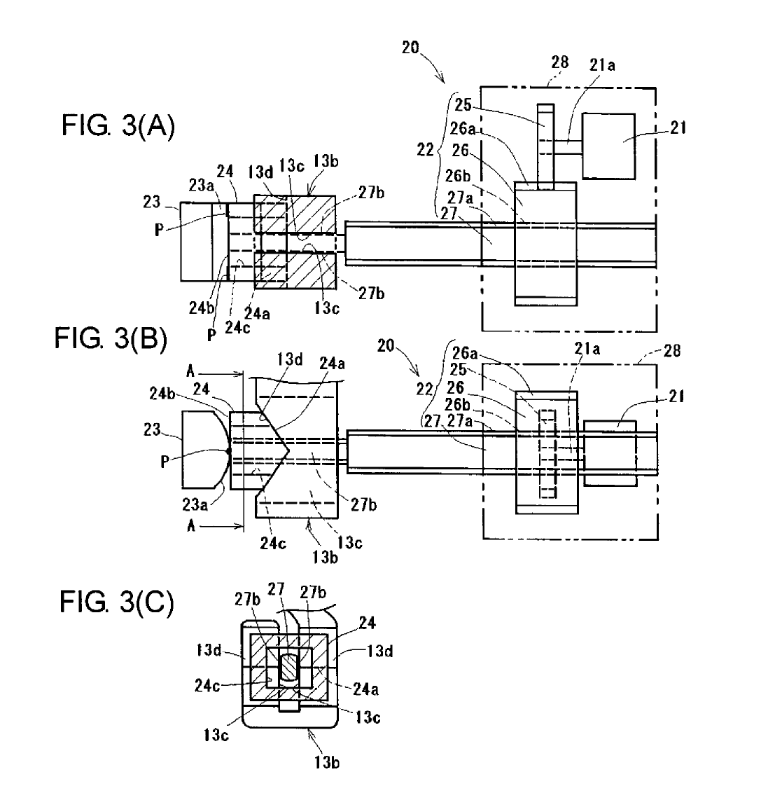

As shown in FIGS. 3(A) to 3(C), facing surfaces 13c, 13c which are almost in parallel to the lever axis L2 are formed on inner sides of the bent portion 13b of the parking lever 13. A small-diameter portion (on the left end side in FIGS. 3(A) and 3(B)) of a screw shaft member 27 referred to later extends between the facing surfaces 13c, 13c of the bent portion 13b.

Furthermore, depression or concave portions 13d, 13d each of which takes a taper shape and whose tapered tips extend almost in parallel to the pivot axis L1 of the pivot support portion 13a are formed on the bent portion 13b on the brake shoe 11a side. An intervention member 24 referred to later is held in contact with the tapered concave portions 13d, 13d of the bent portion 13b.

As shown in FIGS. 3(A) and 3(B), the motor-driven actuator 20 is mainly composed of the electric motor 21, a rotation-linear motion converting mechanism 22, a motion transmitting member 23 and an intervention member 24. The motor 21 and the rotation-linear motion converting mechanism 22 are provided in a housing 28 secured on the back plate 15.

The rotation-linear motion converting mechanism 22 is composed of a pinion 25, a nut member 26 (corresponding to “rotation member” in the claimed invention) and a screw shaft member 27 (corresponding to “axially removable member” in the claimed invention). The rotation-linear motion converting mechanism 22 is a mechanism for converting the rotational motion of the nut member 26 about the axis into the linear motion of the screw shaft member 27 in the axial direction.

The pinion 25 is secured to a rotational shaft 21a of the motor 21. The nut member 26 is rotatably supported in the housing 28. The nut member 26 is provided at its outer surface with gear teeth 26a meshing with the pinion 25 and at its internal surface with a screw hole 26b screw-engaged with a threaded portion 27a of the screw shaft member 27.

The screw shaft member 27 is rotatably supported in the housing 28. The screw shaft member 27 is formed to be larger in diameter on one end side (right end side in FIGS. 3(A) and 3(B)) than on the other end side (left end side in FIGS. 3(A) and 3(B)). And, the large-diameter portion of the screw shaft member 27 is provided with the threaded portion 27a screw-engaged with the screw hole 26b of the nut member 26, as mentioned previously. The small-diameter portion of the screw shaft member 27 is formed with two diametrically opposite flat surfaces 27b, 27b, the distance between which is narrower than the distance between the facing surfaces 13c, 13c of the bent portion 13b of the parking lever 13. The two diametrically opposite flat surfaces 27b, 27b of the screw shaft member 27 are fitted between the facing surfaces 13c, 13c at the bent portion 13b of the parking lever 13 in order to restrain the screw shaft member 27 from rotating about the axis but to permit the same to move in the axis direction.

The motion transmitting member 23 is formed to the shape of an almost rectangular parallelepiped whose one surface takes a convex circular surface 23a, that is, to a semicylindrical shape. On the circular surface 23a side thereof, the motion transmitting member 23 is bodily provided on an extreme end of the small-diameter portion of the screw shaft member 27 with the center axis of the circular surface 23a extending in parallel with the pivot axis L1 of the pivot support portion 13a of the parking lever 13. The motion transmission member 23 is a member that transmits the motion transmitting force in a linear motion in the axial direction of the screw shaft member 27 to the intervention members 24 referred to later. The circular surface 23a of the motion transmitting member 23 is held in contact at a contact portion P with a side surface 24b on the brake shoes 11a side of the intervention members 24.

The intervention member 24 takes the form of an almost rectangular parallelepiped which has a tapered convex portion 24a engageable with the tapered concave portions 13d, 13d on the bent portion 13b of the parking lever 13. The intervention member 24 is made of a material which is higher in hardness than that of the parking lever 13. The intervention member 24 is provided with a through hole 24c of a rectangular section which passes from the convex portion 24a side to a side surface 24b opposite thereto. The small-diameter portion of the screw shaft member 27 passes through the through hole 24c to be tiltable relative thereto. The through hole 24c may be formed to an elongate hole being elliptical in cross-section. Further, by making the parking lever 13 high in hardness, the intervention member 24 may be omitted. In this case, the concave portions 13d, 13d are not required to be provided on the bent portion 13b of the parking lever 13, and the circular surface 23a of the motion transmitting member 23 is made to contact the bent portion 13b of the parking lever 13 at the contact portion P.

(Operation)

Next, the operation of the electric parking brake device 1 will be described. The electric parking brake device 1 is mounted on each of rear wheels of a vehicle (both not shown). Further, parking brake switches (also not shown) for respectively manipulating both of the electric parking brake 1, 1 are provided on a dashboard (not shown) of the vehicle. When bringing the parking brake into work, the driver turns each parking brake switch to ON. Then, the motor 21 rotates, and the rotational motion is transmitted to the nut member 26 through the pinion 25. Thus, the transmitted rotational motion is converted into the linear motion of the screw shaft member 27 toward the right in FIG. 1. Consequently, the parking lever 13 is rotated counterclockwise in FIG. 1.

The parking lever 13 pushes the brake shoe 11a on the drum 16 side and pushes the brake shoe 11b on the drum 16 side through the connecting member 14 to bring the brake linings 12a, 12b into friction engagements with the internal surface of the drum 16. The parking brake is operated in the manner described above. At this time, the motor 21 is stopped when electric current over a predetermined value flows across the motor 21. Thus, a constant parking brake power can be obtained at all times. When releasing the parking brake, the driver turns each parking brake switch to OFF. Thus, the motor 21 is rotated in a direction opposite to the previous direction, whereby the parking brake is released. At this time, the power supply to the motor 21 is switched off when a no-load current is reached. Consequently, a useless energy consumption can be suppressed.

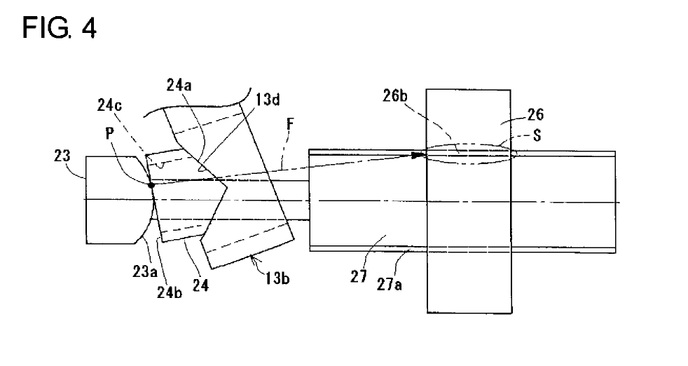

According to the electric parking brake device 1 of the construction described above, there can be obtained advantageous effects as described below. That is, as shown in FIG. 4, one face of the motion transmitting member 23 contacting the intervention member 24 is formed to the circular surface 23a so that when the linear motion of the screw shaft member 27 towards the right causes the parking lever 13 to pivotally move counterclockwise, the force line F of the motion transmitting force at the contact portion P between the motion transmitting member 23 and intervention member 24 is located inside the outer surface S of the engaging portion between the threaded portion 27a of the screw shaft member 27 and the screw hole 26b of the nut member 26, that is, inside the outer surface S in the radial direction of the screw shaft member 27.

Now, let it be assumed that the force line of the motion transmitting force at the contact portion between the motion transmitting member 23 and the intervention member 24 is located outside the outer surface S of the engaging portion between the threaded portion 27a of the screw shaft member 27 and the screw hole 26b of the nut member 26. In this assumed case, the screw shaft member 27 is subjected to a moment in a direction perpendicular to the axis of the screw shaft member 27 in addition to a force exerted on the engaging portion between the threaded portion 27a and the screw hole 26b of the nut member 26 and thus, is urged to revolve. This causes the engaging portion between the threaded portion 27a of the screw shaft member 27 and the screw hole 26b of the nut member 26 to rise or float up, whereby a one-side hitting takes place at the engaging portion.

Further, if the one surface of the motion transmitting member 23 that contacts the intervention member 24 were formed not to the circular surface 23a but to a flat surface, a large slippage would be produced in the movement that the linear motion of the screw shaft member 27 causes the parking lever 13 to pivot about the center of the pivot support portion 13a, and thus, the motion transmitting force by the motion transmitting member 23 would become an offset load.

In the present embodiment, on the contrary, the force line F of the motion transmitting force at the contact portion P between the motion transmitting members 23 and the intervention member 24 is located inside the outer surface S of the engaging portion between the threaded portion 27a of the screw shaft member 27 and the screw hole 26b of the nut member 26 in the radial direction of the screw shaft member 27. In this case, the screw shaft member 27 is subjected only to the force exerted on the engaging portion between the threaded portion 27a and the screw hole 26b of the nut member 26 but is not subjected to the aforementioned moment that urges the screw shaft member 27 to revolve. For this reason, no floating takes place at the engaging portion between the threaded portion 27a of the screw shaft member 27 and the screw hole 26b of the nut member 26, so that the one-side hitting at the engaging portion can be prevented. Therefore, the parking lever 13 can be pivotally moved smoothly. The force line F of the motion transmitting force at the contact portion P between the motion transmitting members 23 and the intervention member 24 resides at a critical point when it extends across the left end of the outer surface S of the engaging portion shown in FIG. 4. It is preferable that the force line F extends across the right end of the outer circular surface S of the engaging portion shown in FIG. 4.

The one surface of the motion transmitting members 23 that contacts the intervention member 24 is formed to the circular surface 23a. Thus, a slippage can be suppressed in the movement that the linear motion of the screw shaft member 27 causes the parking lever 13 to pivot about the center of the pivot support portion 13a. Consequently, the motion transmitting force by the motion transmitting member 23 can be prevented from becoming an offset load, so that the parking lever 13 can be pivotally moved smoothly.

Further, as shown in FIGS. 3(A) to 3(C), the screw shaft member 27 passes through the other end of the parking lever 13 to be relatively movable in the axial direction but to be restrained from relatively rotating, and the motion transmitting member 23 is bodily provided at an extreme end of the screw shaft member 27. That is, at the two diametrically-opposite flat portions 27b, 27b on the small-diameter portion thereof, the screw shaft member 27 is fitted between the facing surfaces 13c and 13c which are formed at the bent portion 13b of the parking lever 13, and thus, is restrained from rotating about the axis of the screw shaft member 27 but is permitted to move in the axial direction. Then, the motion transmitting member 23 is bodily provided on the extreme end of the small-diameter portion of the screw shaft member 27. Therefore, the rotational motion of the nut member 26 can reliably be converted into the linear motion of the screw shaft member 27.

Then, the intervention member 24 of a high hardness which is formed with the through hole 24c through which the screw shaft member 27 passes to be tiltable is interposed between the motion transmitting member 23 and the other end of the parking lever 13. Thus, since the motion transmitting member 23 contacts the intervention member 24 being high in hardness but does not directly contact the parking lever 13, the parking lever 13 is prevented from being deformed at the other end and thus, can be pivotally moved reliably. Further, the parking lever 13 is not required to be high in hardness, so that the machining cost therefor can be reduced. Further, when the movement of the screw shaft member 27 in the axial direction causes the parking lever 13 to pivotally move about the pivot support portion 13a at the one end, no interference takes place between the screw shaft member 27 and the intervention member 24, so that the pivot movement of the parking lever 13 can be done smoothly.

Further, as best shown in FIG. 3(B), the respective contact portions of the other end of the parking lever 13 and the intervention member 24 are respectively formed as the tapered concave portion 13d and the tapered convex portion 24a engageable with the tapered concave portion 13d. Thus, even where the intervention member 24 is held spaced away from the other end of the parking lever 13 when the movement of the screw shaft member 27 in the axial direction causes the parking lever 13 to pivotally move about the pivot support portion 13a at the one end, the intervention member 24 can be positioned to a predetermined place with respect to the other end of the parking lever 13. Therefore, the pivot movement of the parking lever 13 can be done smoothly.

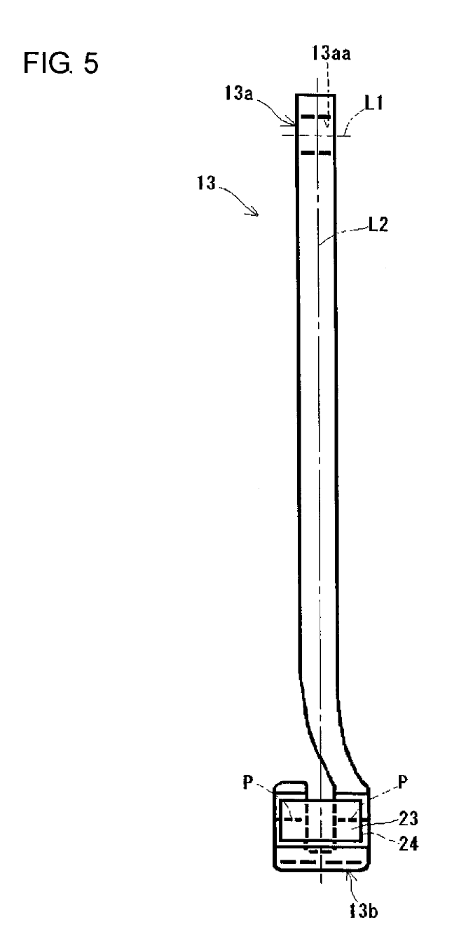

Further, as shown in FIG. 5, the through hole 13aa permitting the tilt motion of the parking lever 13 is formed in the pivot support portion 13a at one end of the parking lever 13. Further, the contact portion P of the motion transmitting member 23 with the intervention member 24 is provided to be located over the both sides (indicated as P, P in FIG. 5) of the lever axis L2 which extends perpendicularly of the pivot axis L1 of the pivot support portion 13a at one end of the parking lever 13. Thus, when the movement of the screw shaft member 27 in the axial direction causes the parking lever 13 to pivotally move about the pivot support portion 13a at the one end, mutual oppositely-directed torsional torques about the lever axis L2 are generated by the motion transmitting force at respective contact portions P, P on the opposite sides between the motion transmitting member 23 and the intervention member 24. Therefore, even if the motion transmitting member 23 is one of those having a certain amount of variation in dimension, the motion transmitting member 23 and the intervention member 24 can be prevented from engaging in a one-side hitting, so that the pivot movement of the parking lever 13 can be done smoothly.

In the foregoing embodiment, the concave circular surface 23a is formed at the contact surface of the motion transmitting member 23 with the intervention member 24. However, the same effect can be realized where a concave circular surface is formed at the contact surface of the intervention member 24 with the motion transmitting member 23. Further, the same effect can be realized where a convex circular surface is formed on one of the contact surfaces of the motion transmitting member 23 and the intervention member 24 while a concave circular surface of the same diameter as the convex circular surface or of a larger diameter is formed on the other of the contact surfaces. Furthermore, the same effect can be realized by forming a curved surface such as, for example, spherical surface without being limited to the circular surface.

Further, the intervention member 24 is formed to the almost rectangular parallelepiped having the tapered convex portion 24a which is engageable with tapered concave portions 13d, 13d at the bent portion 13b of the parking lever 13. However, the shape is not limited to the taper shape, and the same effect can be realized by taking the construction that the intervention member 24 is formed to a rectangular parallelepiped while the bent portion 13b of the parking lever 13 is formed with a concave portion of a rectangular-parallelepiped shape which is engageable with the intervention member 24.

Further, although being constructed as a mechanism that converts the rotational motion of the nut member 26 about the axis to the linear motion of the screw shaft member 27 in the axial direction, the rotation-linear motion converting mechanism 22 may be constructed as a mechanism that converts the rotational motion of the screw shaft member 27 about the axis into the linear motion of the nut member 26 in the axial direction. Where this modified mechanism is taken, the motion transmitting member 23 may, for example, be provided bodily on an extreme end of a member that extends from the nut member 26 in the axial direction. Further, a rack-and-pinion mechanism may be employed as the rotation-linear motion converting mechanism 22.

Various features and many of the attendant advantages in the foregoing embodiment will be summarized as follows:

In the electric parking brake device in the foregoing embodiment typically shown in FIGS. 1 and 4, the aforementioned contact portion P is formed so that the force line F of the motion transmitting force at the contact portion P between the motion transmitting member 23 and the other end of the parking lever 13 is located inside the outer surface S of the engaging portion between the rotation member 26 and the axially movable member 27. If the force line F of the motion transmitting force were located outside the outer surface S of the engaging portion between the rotation member 26 and the axially movable member 27, a moment in a direction perpendicular to the axis of the axially movable member 27, in addition to the force exerted on the engaging portion between the axially movable member 27 and the rotation member 26, would be exerted on the axially movable member 27 to urge the axially movable member 27 to revolve, and thus, it would be the case occasionally that a floating takes place at the engaging portion between the rotation member 26 and the axially movable member 27 to bring about a one-side hitting therebetween. In the foregoing embodiment, on the contrary, the force line F of the motion transmitting force is located inside the outer surface S of the engaging portion between the rotation member 26 and the axially movable member 27. In this case, only the force acting at the engaging portion between the axially movable member 27 and the rotation member 26 is exerted on the axially movable member 27, and there is not produced any moment that causes the aforementioned axially movable member 27 to revolve. Thus, no floating takes place at the engaging portion between the rotation member 26 and the axially movable member 27, so that the one-side hitting at the engaging portion can be prevented. Therefore, the pivot movement of the parking lever 13 can be carried out smoothly.

Also in the electric parking brake device in the foregoing embodiment typically shown in FIGS. 1 and 4, at least one of the contact portions 23a of the motion transmitting member 23 and the other end of the parking lever 13 takes a curved surface. Thus, there can be suppressed a slippage in the movement that the linear motion of the axially movable member 27 causes the parking lever 13 to pivotally move about the pivot support portion 13a at one end thereof. As a result, the motion transmitting force by the motion transmitting member 23 is prevented from becoming an offset load, so that the pivot movement of the parking lever 13 can be carried out smoothly.

Also in the electric parking brake device in the foregoing embodiment typically shown in FIGS. 1 and 4, the intervention member 24 of a high hardness formed with the through hole 24c through which the axially movable member 27 passes to be tiltable is interposed between the motion transmitting member 23 and the other end of the parking lever 13. Thus, since the motion transmitting member 23 contacts the intervention member 24 and does not directly contact the parking lever 13, it becomes possible to prevent the other end of the parking lever 13 from being deformed and hence, to pivotally move the parking lever 13 reliably. Further, the parking lever 13 is not required to be high in hardness, thus reducing the cost in machining. Furthermore, when the relative movement of the axially movable member 27 in the axial direction causes the parking lever 13 to pivotally move about the pivot support portion 13a at one end thereof, no interference occurs between the axially movable member 27 and the intervention member 24, so that the pivot movement of the parking lever 13 can be done smoothly. In addition, the axially movable member 27 passes through the other end of the parking lever 13 to be relatively movable in the axial direction but to be restrained from relatively rotating, and the motion transmission member 23 is bodily provided on one end of the axially movable member 27. Therefore, it becomes possible to reliably convert the rotation motion of the rotation member 26 into the linear motion of the axially movable member 27.

Also in the electric parking brake device in the foregoing embodiment typically shown in FIG. 4, the respective contact portions on the other end of the parking lever 13 and the intervention member 24 are formed to the tapered depression or concave portion 13d and the tapered protrusion or convex portion 24a engageable with the tapered concave portion 13d. Thus, even where the intervention member 24 is spaced away from the other end of the parking lever 13 when the relative movement of the axially movable member 27 in the axial direction causes the parking lever 13 to pivotally move about the pivot support portion 13a at one end thereof, the intervention member 24 can be positioned to the predetermined place relative to the other end of the parking lever 13, so that the pivot movement of the parking lever 13 can be done smoothly.

Further, in the electric parking brake device in the foregoing embodiment typically shown in FIG. 5, the through hole 13aa that permits the tilt motion of the parking lever 13 is formed in the pivot support portion 13a at one end of the parking lever 13. Further, the contact portion P of the motion transmitting member 23 with the other end of the parking lever 13 is formed to be located over both sides of the lever axis L2 which extends perpendicularly of the pivot axis L1 at the one end of the parking lever 13. Thus, when the relative movement of the axially movable member 27 in the axial direction causes the parking lever 13 to pivotally move about the pivot support portion 13a at one end thereof, mutual oppositely-directed torsional torques are generated by the motion transmitting force at the contact portions P, P on the opposite sides between the motion transmitting member 23 and the other end of the parking lever 13. Therefore, the motion transmitting member 23 and the other end of the parking lever 13 are prevented from contacting only on one side of the lever axis L2, so that the pivot movement of the parking lever 13 can be done smoothly.

Obviously, numerous further modifications and variations of the present invention are possible in light of the above teachings. It is therefore to be understood that within the scope of the appended claims, the present invention may be practiced otherwise than as specifically described herein.

What is claimed is:

1. An electric parking brake device comprising:
a pair of brake shoes respectively having brake linings frictionally engageable with a drum and pivotally supported on a back plate;
a parking lever pivotally supported by one of the brake shoes at one end thereof and having a connecting member interposed between itself and the other of the brake shoes for widening the pair of brake shoes against the drum to bring the pair of brake linings into friction engagements with the drum when pivotally moved;
an electric motor secured to the back plate;
a rotation-linear motion converting mechanism having a rotation member and an axially movable member mutually engaged at an engaging portion for converting a rotational motion to a linear motion when the rotation member is rotationally driven by the electric motor with the axially movable member restrained from rotating; and
a motion transmitting member connected to the axially movable member for transmitting the linear motion converted by the rotation-linear motion converting mechanism to the other end of the parking lever through a contact with the other end of the parking lever;
wherein a contact portion between the motion transmitting member and the other end of the parking lever is formed so that the force line of a motion transmitting force at the contact portion between the motion transmitting member and the other end of the parking lever is located inside an outer surface of the engaging portion between the rotation member and the axially movable member.

2. The electric parking brake device in claim 1, wherein at least one of contact portions of the motion transmitting member and the other end of the parking lever takes a curved surface.

3. The electric parking brake device in claim 1, wherein:
the axially movable member axially movably passes through the other end of the parking lever to be restricted from rotating relative to the other end of the parking lever and is bodily provided with the motion transmitting member at one end thereof; and
an intervention member of a high hardness formed with a through hole through which the axially movable member passes to be tiltable is interposed between the motion transmitting member and the other end of the parking lever.

4. The electric parking brake device in claim 3, wherein respective contact portions of the other end of the parking lever and the intervention member are formed to a tapered concave portion and a tapered convex portion engageable with the tapered concave portion.

5. The electric parking brake device in claim 1, wherein:
a through hole that permits a tilt motion of the parking lever is formed in the pivot support portion at one end of the parking lever; and
the motion transmitting member is provided with contact portions that contact the other end of the parking lever on both sides of a lever axis extending perpendicularly of a pivot axis at one end of the parking lever.

6. The electric parking brake device in claim 3, wherein:
a through hole that permits a tilt motion of the parking lever is formed in the pivot support portion at one end of the parking lever; and
the motion transmitting member is provided with contact portions that contact the other end of the parking lever on both sides of a lever axis extending perpendicularly of a pivot axis at one end of the parking lever.
